(19) United States
(12) Patent Application Publication
(10) Pub. No.: US 2026/0142858 A1
(43) Pub. Date: May 21, 2026

(54) OVERLAND SYNCHRONIZATION SIGNAL (SS) BLOCK STRUCTURES AND CELL DETECTION PROCEDURES

(71) Applicant: Lenovo (United States) Inc., Morrisville, NC (US)

(72) Inventors: Karthikeyan GANESAN, Nauheim (DE); Ali Ramadan ALl, Kraiburg am Inn (DE); Ravi KUCHIBHOTLA, Chicago, IL (US)

(21) Appl. No.: 18/949,602

(22) Filed: Nov. 15, 2024

(51) Int. Cl. H04L 27/04; H04L 5/00; H04L 27/06

(52) U.S. Cl. CPC H04L 27/04; H04L 5/0007; H04L 27/06

(57) ABSTRACT

Various aspects of the present disclosure relate to a signaling mechanism, such as a mechanism that implements an overlaid synchronization signal (SS) block structure or design, to detect minimized signals transmitted by the base station during initial synchronization procedures. For example, the new signaling may comprise SS blocks that include overlaid sequence carrying information, such as a synchronization signal overlaid within an ON duration of an on-off keying (OOK) pulse.

### TECHNICAL FIELD

The present disclosure relates to wireless communications, and more specifically to overlaid synchronization signal (SS) block structures and cell detection procedures.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communications system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

Some UEs may be low power devices, such as devices that are power-sensitive and/or have small form factors (e.g., Internet of Things (IoT) devices, wearables, and so on). Other UEs (such as extended reality (XR) devices and smart phones) act as low power devices during certain operations. These UEs (or other user devices) may include a low power wake up radio (LP-WUR) that receives a low power wake up signal (LP-WUS) from a base station and wakes up a main radio (e.g., a new radio (NR) main receiver) of the UE.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatuses, and systems that enable a network to provide overlaid SS block structures and cell detection procedures for low power implementations.

A network entity for wireless communication is described. The network entity may be configured to, capable of, or operable to perform one or more operations as described herein. For example, the network entity may comprise at least one memory and at least one processor coupled with the at least one memory and configured to cause the network entity to configure an overlaid block to include an overlaid OFDM sequence within an ON-OFF keying (OOK) ON symbol, wherein the overlaid OFDM sequence comprises an SS having a primary synchronization signal (PSS) and a secondary synchronization signal (SSS) overlaid within one or more OOK ON symbols included in a binary sequence of the OOK, and transmit the configured overlaid SS block in an OFDM symbol included in a slot.

A method performed or performable by network entity is described. The method may comprise configuring an overlaid block to include an overlaid OFDM sequence within an ON-OFF keying (OOK) ON symbol, wherein the overlaid OFDM sequence comprises an SS having a primary synchronization signal (PSS) and a secondary synchronization signal (SSS) overlaid within one or more OOK ON symbols included in a binary sequence of the OOK and transmitting the configured overlaid SS block in an OFDM symbol included in a slot.

In some implementations of the network entity and method described herein, the network entity and method may further be configured to, capable of, performed, performable, or operable to generate the OOK symbol using one OFDM symbol, wherein the OOK symbol comprises an OOK chip.

In some implementations of the network entity and method described herein, the network entity and method may further be configured to, capable of, performed, performable, or operable to generate multiple OOK symbols using one OFDM symbol, wherein each OOK symbol comprises an OOK chip.

In some implementations of the network entity and method described herein, the network entity and method may further be configured to, capable of, performed, performable, or operable to generate the multiple OOK symbols using a discrete Fourier transform (DFT) or a least squares (LS) transform.

In some implementations of the network entity and method described herein, an overlaid SS mapping within the binary sequence of the OOK comprises the PSS transmitted within a first occurrence of the OOK ON symbol in the OFDM symbol and the SSS transmitted within a second occurrence of the OOK ON symbol in the OFDM symbol, and wherein the PSS and SSS are mapped to adjacent chips of multiple chips associated with the one or more OOK ON symbols.

In some implementations of the network entity and method described herein, an overlaid SS mapping within the binary sequence of the OOK comprises a first PSS adjacent to a second PSS, and wherein the first PSS and the second PSS are mapped to adjacent chips of multiple chips associated with the one or more OOK ON symbols.

In some implementations of the network entity and method described herein, an overlaid SS mapping within the binary sequence of the OOK comprises a first SSS adjacent to a second SSS, and wherein the first SSS and the second SSS are mapped to adjacent chips of multiple chips associated with the one or more OOK ON symbols.

In some implementations of the network entity and method described herein, the network entity and method may further be configured to, capable of, performed, performable, or operable to transmit the overlaid SS block within the binary sequence of the OOK at a same default candidate location in the slot where the PSS and SSS are transmitted.

In some implementations of the network entity and method described herein, the overlaid SS block comprises two repeated PSSs adjacent to two repeated SSSs.

In some implementations of the network entity and method described herein, the network entity and method may further be configured to, capable of, performed, performable, or operable to transmit, using multiple beams, an overlaid sequence burst containing multiple overlaid SS blocks.

In some implementations of the network entity and method described herein, the network entity and method may further be configured to, capable of, performed, performable, or operable to transmit a physical cell identifier for the network entity that comprises the PSS, the SSS, and the overlaid SS.

A UE for wireless communication is described. The UE may be configured to, capable of, or operable to perform one or more operations as described herein. For example, the UE may comprise at least one memory and at least one processor coupled with the at least one memory and configured to cause the UE to receive an overlaid SS block that includes an overlaid OFDM within an OOK ON symbol, wherein the overlaid OFDM sequence comprises an SS having a PSS and an SSS overlaid within OOK ON symbols of a binary sequence of the OOK and detect the SS within the overlaid SS block.

A processor for wireless communication is described. The processor may be configured to, capable of, or operable to perform one or more operations as described herein. For example, the processor may comprise at least one controller coupled with at least one memory and configured to cause the processor to receive an overlaid SS block that includes an overlaid OFDM within an OOK ON symbol, wherein the overlaid OFDM sequence comprises an SS having a PSS and an SSS overlaid within OOK ON symbols of a binary sequence of the OOK and detect the SS within the overlaid SS block.

A method performed or performable by a UE is described. The method may comprise receiving an overlaid SS block that includes an overlaid OFDM within an OOK ON symbol, wherein the overlaid OFDM sequence comprises an SS having a PSS and an SSS overlaid within OOK ON symbols of a binary sequence of the OOK and detecting the SS within the overlaid SS block.

In some implementations of the reader device, processor, and method described herein, the overlaid SS block comprises two repeated PSSs adjacent to two repeated SSSs.

In some implementations of the UE, processor, and method described herein, the UE, processor, and method may further be configured to, capable of, performed, performable, or operable to perform an initial synchronization with the network entity using the OFDM sequence and determine a cell identifier for the network entity using the PSS, the SSS and the overlaid SS.

### BRIEF DESCRIPTION OF THE DRAWINGS

FIG. 1 illustrates an example of a wireless communications system in accordance with aspects of the present disclosure.

FIG. 2 illustrates an example of signaling a UE in accordance with aspects of the present disclosure.

FIGS. 3A-3B illustrate examples of overlaid sequences in accordance with aspects of the present disclosure.

FIG. 4 illustrates an example of an overlaid sequence with repeated SSs in accordance with aspects of the present disclosure.

FIGS. 5A-5B illustrate example waveforms for overlaid sequences in accordance with aspects of the present disclosure.

FIG. 6 illustrates an example of an SS burst with an overlaid synchronization burst in accordance with aspects of the present disclosure.

FIG. 7 illustrates an example PCI mapping in accordance with aspects of the present disclosure.

FIG. 8 illustrates example signaling for cell detection in accordance with aspects of the present disclosure.

FIG. 9 illustrates an example of a UE in accordance with aspects of the present disclosure.

FIG. 10 illustrates an example of a processor in accordance with aspects of the present disclosure.

FIG. 11 illustrates an example of a network equipment (NE) in accordance with aspects of the present disclosure.

FIG. 12 illustrates a flowchart of a method performed by an NE in accordance with aspects of the present disclosure.

FIG. 13 illustrates a flowchart of a method performed by a UE in accordance with aspects of the present disclosure.

### DETAILED DESCRIPTION

A wireless communications system may support UEs performing a search to identify and connect to a base station (e.g., a serving cell) for future communications. During such cell search operations, the UE receives and utilizes SS from a cell (e.g., a serving cell or a base station or other network entity) to determine information that enables the UE to access the cell (e.g., camp on the cell). For example, the cell may transmit SS blocks every 5 milliseconds or with other periodicities (e.g., 5 ms, 10 ms, 20 ms, and so on). To provide coverage over an entire cell area, the cell may perform beam sweeping. Beam sweeping entails communication of one or more cell defining SS block bursts (or burst sets), where each SS block burst includes a set of SS blocks, and where each SS block may be transmitted by a different (e.g., separate) beam. For 5G (e.g., NR) wireless access technologies, the SSB burst size is 5 ms (e.g., half of a radio frame), where the SS blocks are transmitted in a first half or a second half of a radio frame. Based on the frequency range and subcarrier spacings of the cell, the maximum candidate SSBs is 64, which can be accommodated by 5 ms SSB burst sizes.

A lower power device (e.g., a low power UE) having a low power radio (e.g., the LP-WUR) may suffer from problems associated with detecting SS, because the LP-WUR radio has limited coverage and detection capabilities. For example, while the LP-WUR may achieve power saving by utilizing an envelope detector to detect OOK waveforms from a base station, such detection is less robust and has limited coverage compared to other, more power-intensive techniques employed by other receiver types (e.g., IQ (in-phase and quadrature-phase) correlator receiver types).

The systems and methods described herein introduce a new signaling mechanism, such as via an overlaid SS block structure or design, to detect minimized signals (e.g., LP-WUSs) transmitted by the base station during initial synchronization procedures. For example, the new signaling may include SS blocks that include overlaid OFDM sequence carrying information. The overlaid OFDM sequence carrying information may include an OOK pulse (e.g., OOK-1 or OOK-4), an OFDM sequence transmitted within an ON duration of an OOK pulse, and an SS overlaid within the ON duration of the OOK pulse.

Thus, the base station may transmit a unified waveform that includes an overlaid OFDM sequence (e.g., within the ON-duration of the OOK), which can be utilized by a main radio and/or a low power radio during initial synchronization. The signal, or unified waveform, facilitates the detection (and synchronization) for UEs that implement low power and/or energy saving capabilities, among other benefits.

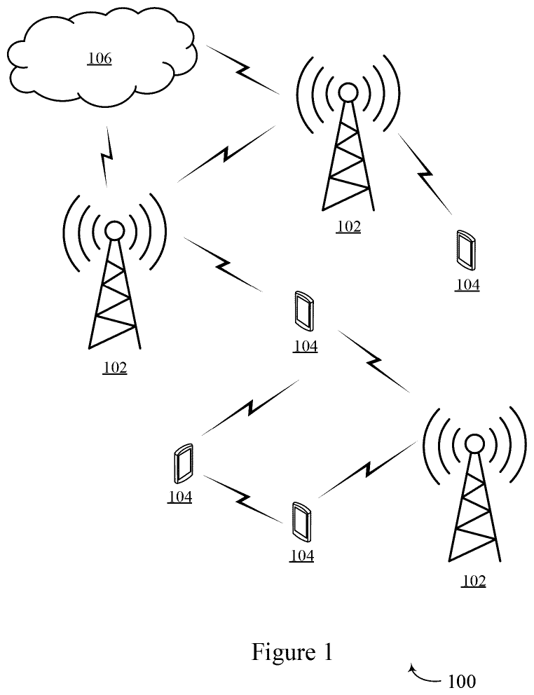

FIG. 1 illustrates an example of a wireless communications system 100 in accordance with aspects of the present disclosure. The wireless communications system 100 may include one or more NE 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

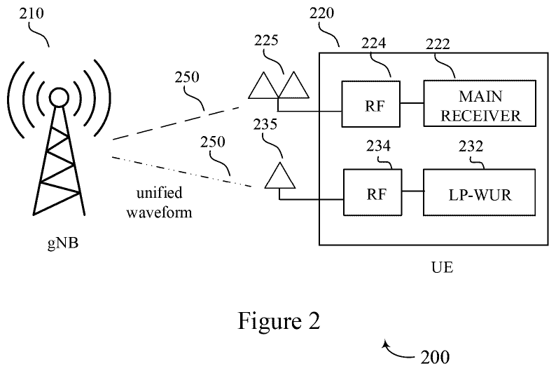

As described herein, in some embodiments, a base station may be configured to transmit a unified waveform (e.g., containing overlaid SS blocks) to a UE (e.g., the UE 104) that includes a low power radio, such as an LP-WUR. For instance, an NE 102 may configure an overlaid SS block to include an overlaid OFDM sequence within an OOK ON symbol. In some cases, the overlaid OFDM sequence may include an SS including a PSS and a SSS overlaid within OOK ON symbols included in a binary sequence of the OOK. The NE 102 may then transmit the overlaid SS block in an OFDM symbol in a slot. FIG. 2 illustrates an example of signaling 200 a UE in accordance with aspects of the present disclosure.

A UE 220 may be configured to detect signaling from a base station 210, such as a gNB or eNodeB. The UE 220 includes a main receiver 222 (e.g., an MR, such as an NR radio) associated with a radio frequency (RF) component 224 and a low power receiver 232 (e.g., an LR, such as an LP-WUR) associated with an RF component 234. The main receiver 222 may be coupled with an antenna 225 configured to detect main signals (e.g., NR signals) from the base station 210. The low power receiver 232 may be coupled with an antenna 235 configured to detect low power signals (LP-WUSs). In some cases, the low power receiver 232 is part of a transmitting or receiving IoT device, and/or a low power auxiliary chipset of the UE 220.

The base station 210 is configured to transmit a unified waveform 250. The unified waveform 250 may include an overlaid OFDM sequence (e.g., PSS and SSS overlaid within the ON-duration of an OOK), which can be utilized by the main receiver 222 and/or the low power receiver 232 during an initial synchronization between the UE 220 and the base station 210.

The unified waveform 250 may include overlaid OFDM sequence carrying information having an OOK symbol/pulse (e.g., OOK-1 or OOK-4), an OFDM sequence transmitted within an ON symbol of an OOK chip/pulse, and an SS sequence used for the transmission of PSS and SSS overlaid within the ON symbol of the OOK symbol/chip/pulse, as described herein. Thus, the unified waveform 250 may include a harmonized OOK/(frequency-shift keying (FSK) type waveform configured to wake up the LP-WUR of the UE 220.

In some cases, the unified waveform 250 is a low power SS (LP-SS) transmitted to the UE 220, enabling the UE 220 to detect the unified waveform 250, wake up the main receiver 222 and cause the UE 220 to initiate synchronization with the base station 210. The LP-SS may include binary sequences. In some examples, a transmitter (e.g., a base station or NE 102) may determine a binary sequence for inclusion in the LP-SS. For example, the binary sequences may be determined as a combination of a number of chips M (e.g., 0 or 1 values) and a sequence length. Example binary sequences include a sequence where M=1 and L={4, 6, 8}, M=2 and L={8, 12, 16, 24}, M=4 and L={16, 24, 32, 56}, and so on. The configuration of the unified waveform 250, as an LP-SS, may include overlaid OFDM sequences, which utilize OOK-1 and OOK-4 waveforms.

Further, the UE 220 may be configured to decode the PSS and the SSS of the unified waveform 250 in order to determine a physical cell identity (PCI), or cell identifier (ID) for the base station 210. The UE 220, as described herein, may determine the PCI by using the PSS, the SSS, and the overlaid sequence.

In some embodiments, the base station 210 may be configured to overlay the PSS and SSS sequence used for initial synchronization within the ON duration of the OOK pulse/binary sequence/waveform. The OOK pulse may be generated using OOK-1 or OOK-4, and the number of chips (e.g., M=1, 2, 4, 8) and an OOK binary sequence may be fixed (e.g., having an equal number of 1s and 0s).

In some cases, the low power receiver 232 may include different receiver types, such as a receiver having an energy detection type and a receiver having an OFDM sequence correlation type. When the low power receiver 232 includes the energy detection type, the low power receiver 232 utilizes the OOK/FSK pattern (e.g., 01100110) transmission from the SS for synchronization purposes. When the low power receiver 232 includes the receiver having the sequence correlation type, the low power receiver 232 utilizes the overlaid sequence of the PSS and the SSS for synchronization purposes and to detect the cell ID (e.g., PCI) of the base station 210.

In some embodiments, the base station 210 may configure the unified waveform 250 using an OOK-1 based overlaid synchronization. For example, the base station 210 may generate one OOK binary sequence from one OFDM symbol (e.g., an 8-bit OOK pattern uses 8 OFDM symbols). In some cases, use of the OOK-1 may mitigate against timing errors but may lack some flexibility when configuring multiple chips within an. OFDM symbol.

In some embodiments, the base station 210 may configure the unified waveform 250 using an OOK-4 based overlaid synchronization. For example, the base station 210 may generate M chips of on an OOK binary sequence from one OFDM symbol (e.g., by applying a discrete Fourier transform (DFT) or a least square transform) before an inverse fast Fourier transform (IFFT) operation. Thus, an 8-bit OOK pattern may use two OFDM symbols, assuming M=4 OOK pulses per OFDM symbol). In some cases, DFT-based OFDM may balance timing errors, due to chip duration, with a higher data rate.

In some cases, time domain mapping of an overlaid SS block may be based on a synchronization binary pattern or sequence (e.g., predefined in a specification). Table 1 depicts the mapping using an OOK-4 waveform as an example for a frequency less than 3.5 GHz (or other frequency ranges predefined in the specification.

TABLE 1

| | | | OOK |
|---|---|---|---|
| | OFDM starting | | starting |
| | symbol of | OOK type and | chip within |
| SCS and | candidate | M value and | OFDM |
| frequency range | overlaid SS | sequence length | symbol |
| 15 kHz, FR1 < | 1, 3, 5, 7, 9, 11, | OOK-4, M = 4, | 2, 3, 5, 6 |
| 3.5 GHz | 13, . . . | L = 8 | |

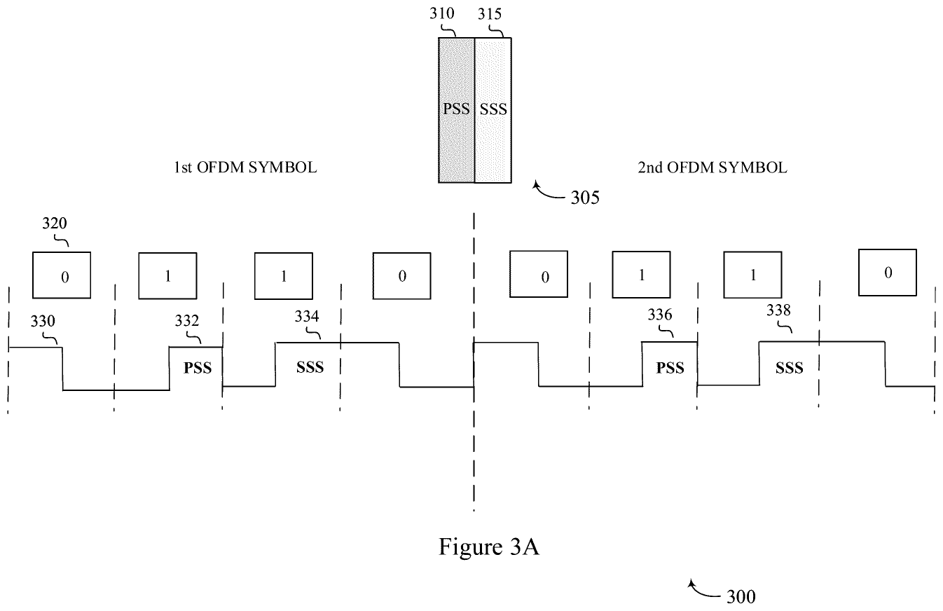

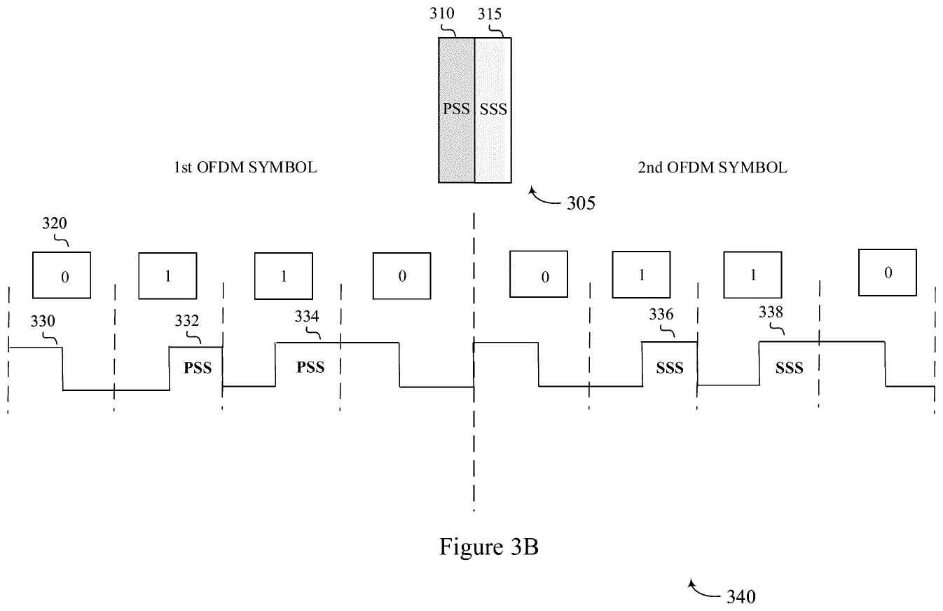

FIGS. 3A-3B illustrate examples of overlaid sequences in accordance with aspects of the present disclosure. FIG. 3A depicts a mapping 300 of an overlaid SS 305 including a PSS 310 and an SSS 315 within two OFDM symbols (e.g., a first OFDM symbol and a second OFDM symbol). The mapping 300 includes M=4 chips 320 (e.g., OOK chips) for each OFDM symbol, such as adjacent OOK chips within a OOK ON duration chip of an OOK binary sequence 330.

An overlaid PSS is mapped to a first occurrence of a “1” (e.g., an OOK ON-duration chip 332 of the first OFDM symbol) of an overlaid SS block, followed by an overlaid SSS mapped to a second OOK ON-duration chip 334 (e.g., a subsequent chip having a “1”). Similarly, an overlaid PSS is mapped to a first occurrence of a “1” (e.g., an OOK ON-duration chip 336 of the second OFDM symbol) of the overlaid SS block, followed by an overlaid SSS mapped to a second OOK ON-duration chip 338 (e.g., a subsequent chip having a “1”).

Table 2 presents the resources within an OOK-4 overlaid SS block for the PSS and SSS.

TABLE 2

| | OOK pulse | OFDM symbol | Subcarrier |
|---|---|---|---|
| Channel | number/relative | number/relative | number k relative |
| or | to the start of | to the start of | to the start of |
| signal | an SS block | an SS block | an SS block |
| PSS | 1 | 0 | 56, 57, . . . , 182 |
| PSS | 5 | 1 | 56, 57, . . . , 182 |
| SSS | 2 | 0 | 56, 57, . . . , 182 |
| SSS | 6 | 1 | 56, 57, . . . , 182 |
| Set to 0 | 0-7 | 0, 1 | 0, 1, . . . , 55, 183, |
| | | | 184, . . . , 239 |

FIG. 3B depicts a mapping 340 of the overlaid SS 305 including the PSS 310 and the SSS 315 within the two OFDM symbols. The mapping 340 includes an overlaid SS block containing a repeated PSS sequence mapped in adjacent OOK chips (e.g., the OOK ON-duration chips 332, 334) within the OOK binary sequence 330 of the first OFDM symbol. The mapping 340 also includes an overlaid SS block containing a repeated SSS sequence mapped in adjacent OOK chips (e.g., the OOK ON-duration chips 336, 338) within the OOK binary sequence 330 of the second OFDM symbol.

Table 3 presents the resources within an OOK-4 overlaid SS block for the PSS and SSS (e.g., repeated PSS or SSS).

TABLE 3

| | OOK pulse | OFDM symbol | Subcarrier |
|---|---|---|---|
| Channel | number/relative | number/relative | number k relative |
| or | to the start of | to the start of | to the start of |
| signal | an SS block | an SS block | an SS block |
| PSS | 1 | 0 | 56, 57, . . . , 182 |
| PSS | 2 | 1 | 56, 57, . . . , 182 |
| SSS | 5 | 0 | 56, 57, . . . , 182 |
| SSS | 6 | 1 | 56, 57, . . . , 182 |
| Set to 0 | 0-7 | 0, 1 | 0, 1, . . . , 55, 183, |
| | | | 184, . . . , 239 |

In some cases, where the OOK binary sequence does not include contiguous OOK ON-duration chips, an PSS may be mapped in the first occurrence of the OOK chip on-duration, followed by an overlaid repetition of the PSS sequence mapped to the second occurrence of the OOK chip on-duration.

The OOK binary sequence (e.g., the OOK-4 or OOK-1 binary sequences) generated using one or more values for M or L, may be configured or predefined based on a subcarrier spacing (SCS) and/or frequency range. In such cases, a UE (e.g., the UE 220) may utilize the overlaid sequence for an initial cell search and/or cell ID detection (see Table 1). Further, in some cases, the base station 210 may not signal a waveform type (e.g., the OOK-1, the OOK-4, the M value, binary sequence length, or fixed binary sequence/pattern of the OOK-4).

In some embodiments, the base station 210 may transmit the periodic overlaid sequence within an OOK symbol of the periodic OOK binary sequence/pattern, in a common candidate location (e.g., a default configuration relative to the start of an overlaid SS block) as the SS including the PSS and the SSS transmission for the initial access. In some cases, the overlaid sequence may be included in an overlaid SS block at a default configured candidate location that includes the SS/PBCH block in a half radio frame. The base station 210 may select the OOK binary sequence/pattern including M chips per OFDM symbol that span a same number of OFDM symbols as that of the SS of the MR (e.g., the main receiver 222) and match the overlaid sequences used for PSS and SSS as the overlaid SS for the LR (e.g., the low power receiver 232) and the MR. In some examples, the OOK binary sequence/pattern may be transmitted at a default OOK symbol location relative to the start of a SS block. The UE 220 may receive the overlaid SS (via the low power receiver 232) as a uniform signal/sequence (e.g., predefined by the OOK binary sequence and the starting OOK chip within the OFDM symbol or binary sequence).

In some cases, the overlaid synchronization sequence may be configured to be detected by the LR and the MR, while the SS may be detected by the MR. The overlaid SS burst periodicity may be an integer multiple of the synchronization burst periodicity.

In some embodiments, such as when there is a repeated SS (e.g., a repeated PSS or SSS), the transmitter (e.g., NE or base station) may increase a binary sequence length by a factor corresponding to the SS block and the repeated SS.

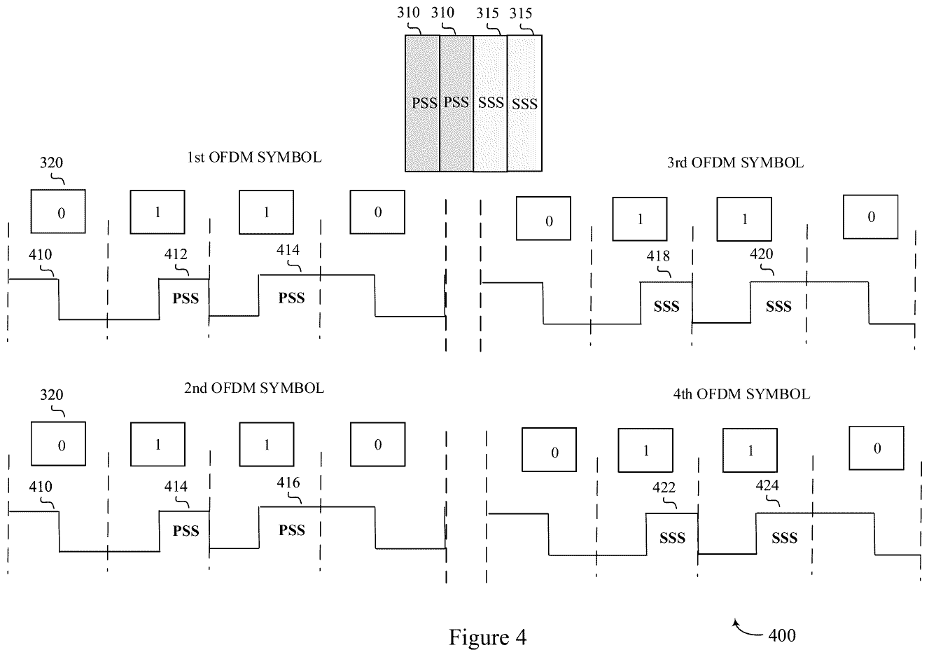

FIG. 4 illustrates an example of an overlaid sequence with repeated SS in accordance with aspects of the present disclosure. A mapping 400 includes M=4 chips 320 (e.g., OOK chips) for each OFDM symbol, such as adjacent OOK chips within a OOK ON duration chip of an OOK binary sequence 410 for four OFDM symbols. A repetition of an overlaid sequence within a binary pattern may depend on an associated type of sequence transmitted by an SS block. For example, when the PSS 310 is repeated in adjacent symbols, the overlaid sequence may include the PSS 310 in the OFDM symbols.

For example, the mapping 400 includes an overlaid SS block including a repeated PSS sequence mapped in adjacent OOK chips (e.g., the OOK ON-duration chips 412, 414) within the OOK binary sequence 410 of a first OFDM symbol. The mapping 400 also includes an overlaid SS block including a repeated PSS sequence mapped in adjacent OOK chips (e.g., the OOK ON-duration chips 414, 414) within the OOK binary sequence 410 of a second OFDM symbol.

The mapping 400 further includes an overlaid SS block containing a repeated SSS sequence mapped in adjacent OOK chips (e.g., the OOK ON-duration chips 418, 420) within the OOK binary sequence 410 of a third OFDM symbol, and a repeated SSS sequence mapped in adjacent OOK chips (e.g., the OOK ON-duration chips 422, 424) within the OOK binary sequence 410 of a fourth OFDM symbol. In some embodiments, an overlaid sequence based on an OOK-1 waveform utilizes one OOK chip per OFDM symbol.

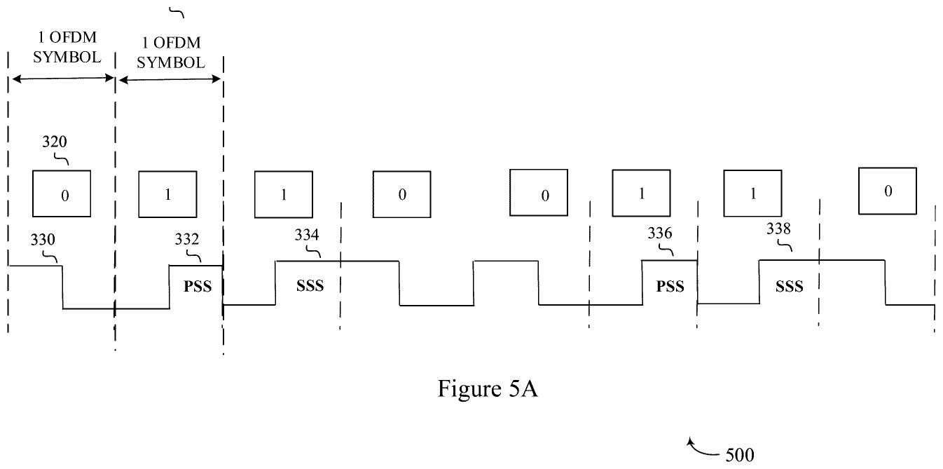

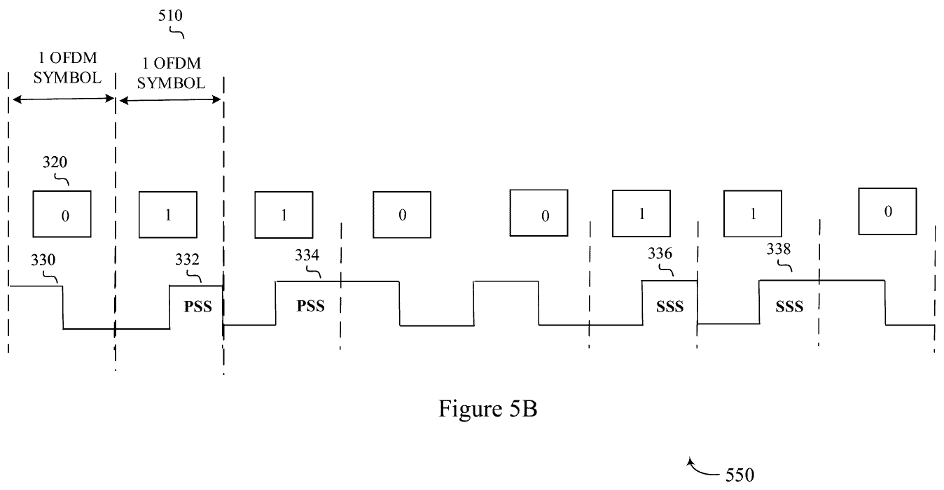

FIGS. 5A-5B illustrate example waveforms for overlaid sequences in accordance with aspects of the present disclosure. A base station (e.g., base station 210) may utilize a longer OFDM symbol duration (e.g., for the OFDM symbol 510) when transmitting a binary sequence (e.g., the OOK binary sequence 330) for synchronization (e.g., using a longer periodicity or on demand).

In some embodiments, the base station 210 may transmit an overlaid sequence burst containing multiple overlaid sequences using different transmission beams.

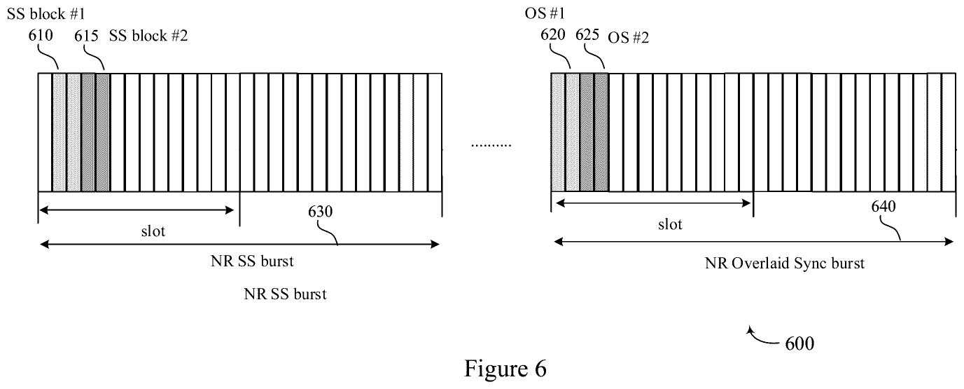

FIG. 6 illustrates an example of an SS burst 600 with an overlaid synchronization burst in accordance with aspects of the present disclosure.

The base station 210 may transmit multiple SS blocks 610, 615 (e.g., SS block #1, SS block #2) in an SS burst 630 (e.g., a 6G NR burst) over different or alternating periodicities to overlaid sequence blocks 620, 625 (e.g., OS #1, OS #2) of an overlaid sequence burst 640. In some cases, the overlaid sequence burst 640 may be transmitted on-demand, while the SS burst 630 is periodically transmitted. During on-demand transmission, an uplink wake up signal may indicate a device type or sequence type as part of a request and/or the base station 210 may configure multiple wake up signals for each burst.

In some cases, the SS burst 630 may include a system information block (SIB) that contains position information corresponding to one or more SS (e.g., synchronization position). In other cases, a separate field may signal the synchronization position for the overlaid sequence in the overlaid sequence burst 640, while signaling the SS position in the SS burst 630.

In some embodiments, the UE 220 may be configured to perform radio resource management (RRM) measurements (e.g., serving cell measurements, neighbor cell measurements, and so on) using the SS and the overlaid sequence. The UE 220 may receive the SIB, which contains cell selection evaluation information that is separately configured for the SS and the overlaid sequence. The cell selection evaluation information may include:
Cell selection information (e.g., to be decoded by the main receiver 222) for the SS, such as q-RxLevMin, q-RxLevMinOffset, q-QualMin, q-QualMinOffset, and so on;
Cell selection information (e.g., to be decoded by the main receiver 222) for the overlaid sequence, such as q-RxLevMin, q-RxLevMinOffset, q-QualMin, q-QualMinOffset, and so on;
Cell selection information (e.g., to be decoded by the low power receiver 232) for the overlaid sequence such as q-RxLevMin, q-RxLevMinOffset, q-QualMin, q-QualMinOffset, and so on.

In some cases, cell selection parameter offsets for the overlaid sequence may be separately configured and compared to cell selection parameters for the reference SS to optimize the bits. In some embodiments, a PCI for the base station 210 (or another cell or NE 102) may be based on a PSS, an SSS, and an overlaid SS, or OSS

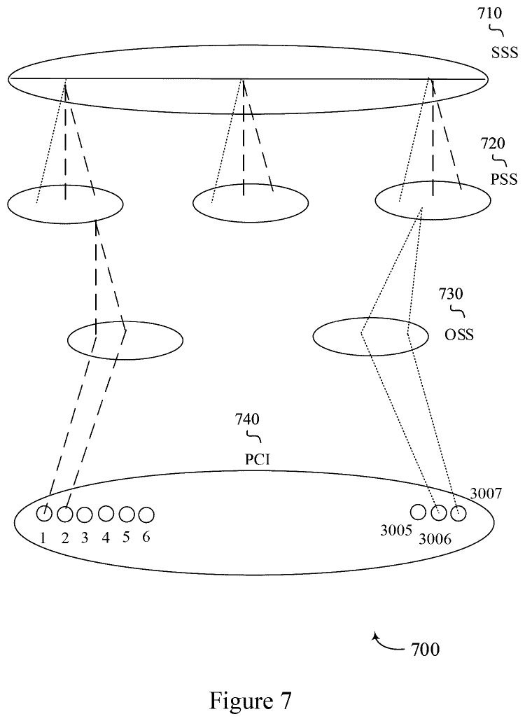

FIG. 7 illustrates an example PCI mapping 700 in accordance with aspects of the present disclosure. As shown, a PCI 740 is mapped to an OSS 730, which is mapped to a PSS 720 and an SSS 710.

The base station 210 may configure a number of orthogonal sequences for the overlaid sequence and/or the binary sequence/pattern, corresponding to different cell IDs. For example, a binary sequence/pattern can be fixed, where a number of sequences are defined for different or individual cells (e.g., avoid inter-cell interferences). As another example, the binary sequence/pattern can vary, where the UE 220 detects the pattern from a predefined list of patterns, such as when the UE 220 includes an envelope detector to identify a cell or part of the cell ID.

In some cases, the overlaid sequence may be configured or defined with a few orthogonal sequences (e.g., 4 or 8), using Zadoff-Chu sequences or other orthogonal sequences, enabling a low power UE (e.g., the UE 220) to detect the sequence with less complexity (and thus detect the cell ID or part of the cell ID). For example, the low power receiver 232 may include an OOK receiver that compares the received binary sequence or pattern with a predefined binary sequence/pattern to detect the cell ID or part of the cell ID.

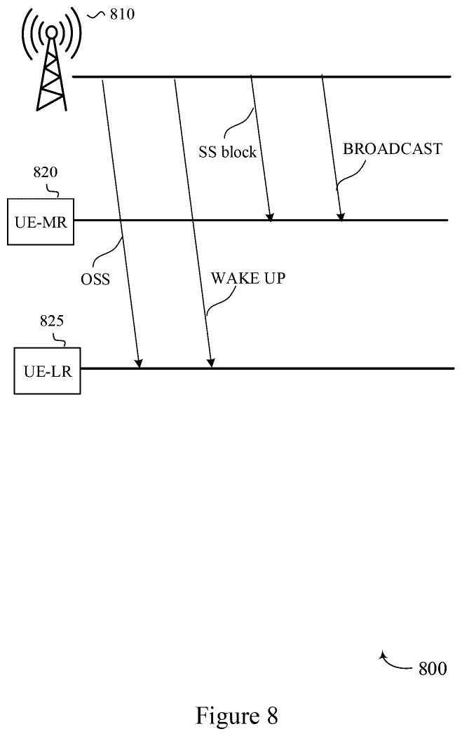

FIG. 8 illustrates example signaling 800 for cell detection in accordance with aspects of the present disclosure. A low power receiver 825 (e.g., a UE-LR), such as the low power receiver 232, receives an OSS from a base station 1110 (e.g., the base station 210), as well as a wake up signal from the base station 1110. After waking up a main receiver 820 (e.g., a UE-MR), such as the main receiver 222, the main receiver 820 receives an SSB (e.g., including the PSS and SSS) and a broadcast signal.

Using the received signals, the UE 220 may determine the PCI as a combination of the PSS, SSS, and the OSS. For example, the UE 220 may determine the PCI as follows:

PCI=MR{x*SSS(0,1,2 . . . 300)+PSS(0,1,2)}+LR{overlaid sequence(0,1,2,3 . . . 8)}.

In some cases, the UE 220 may determine the PCI using other combinations of the PSS, SSS, and/or the OSS. In some cases, the LR may be configured with more than one overlaid sequence as part of the overlaid SS configuration, and the PCI can be a combination of the PSS, the SSS, and a number of sequences configured for the overlaid SS block.

In some embodiments, the overlaid SS block may be a periodic SS, which can be transmitted in a separate overlaid SS burst from the SS burst transmission. The periodicity of the overlaid SS burst can be an integer multiple of the SS burst periodicity and can be separately configured. In some cases, the two bursts can be time division multiplexed.

In some embodiments, the overlaid SS can be transmitted periodically with a default periodicity for the UE to acquire an initial synchronization, while the PSS/SSS of SS block can be transmitted as on-demand. In some embodiments, the overlaid SS can be on-demand while the PSS/SSS of the SS block can be transmitted on-demand.

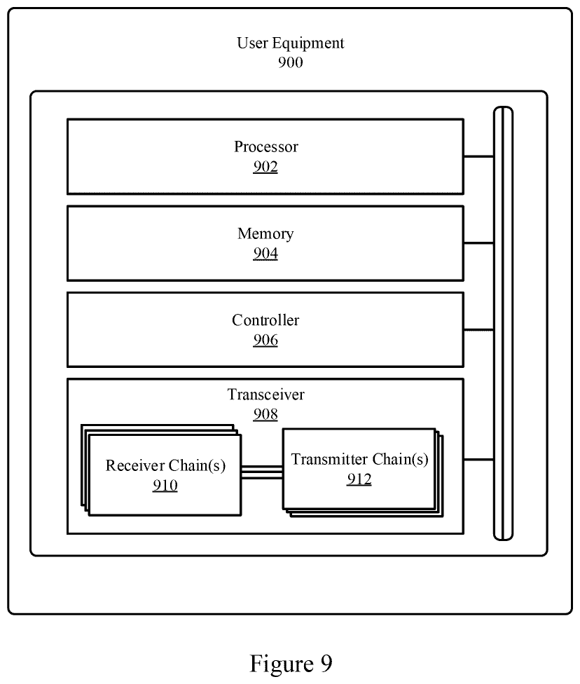

FIG. 9 illustrates an example of a UE 900 in accordance with aspects of the present disclosure. The UE 900 may include a processor 902, a memory 904, a controller 906, and a transceiver 908. The processor 902, the memory 904, the controller 906, or the transceiver 908, or various combinations thereof or various components thereof may be examples of means for performing various aspects of the present disclosure as described herein. These components may be coupled (e.g., operatively, communicatively, functionally, electronically, electrically) via one or more interfaces.

The processor 902, the memory 904, the controller 906, or the transceiver 908, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 902 may include an intelligent hardware device (e.g., a general-purpose processor, a DSP, a CPU, an ASIC, an FPGA, or any combination thereof). In some implementations, the processor 902 may be configured to operate the memory 904. In some other implementations, the memory 904 may be integrated into the processor 902. The processor 902 may be configured to execute computer-readable instructions stored in the memory 904 to cause the UE 900 to perform various functions of the present disclosure.

The memory 904 may include volatile or non-volatile memory. The memory 904 may store computer-readable, computer-executable code including instructions when executed by the processor 902 cause the UE 900 to perform various functions described herein. The code may be stored in a non-transitory computer-readable medium such the memory 904 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 902 and the memory 904 coupled with the processor 902 may be configured to cause the UE 900 to perform one or more of the functions described herein (e.g., executing, by the processor 902, instructions stored in the memory 904).

For example, the processor 902 may support wireless communication at the UE 900 in accordance with examples as disclosed herein. The UE 900 may be configured to support a means for receiving an overlaid SS block that includes an overlaid OFDM sequence within an OOK ON symbol, wherein the overlaid OFDM sequence comprises an SS having a PSS and an SSS overlaid within OOK ON symbols of a binary sequence of the OOK and detecting the SS within the overlaid SS block.

The controller 906 may manage input and output signals for the UE 900. The controller 906 may also manage peripherals not integrated into the UE 900. In some implementations, the controller 906 may utilize an operating system such as iOS®, ANDROID®, WINDOWS®, or other operating systems. In some implementations, the controller 906 may be implemented as part of the processor 902.

In some implementations, the UE 900 may include at least one transceiver 908. In some other implementations, the UE 900 may have more than one transceiver 908. The transceiver 908 may represent a wireless transceiver. The transceiver 908 may include one or more receiver chains 910, one or more transmitter chains 912, or a combination thereof.

A receiver chain 910 may be configured to receive signals (e.g., control information, data, packets) over a wireless medium. For example, the receiver chain 910 may include one or more antennas for receive the signal over the air or wireless medium. The receiver chain 910 may include at least one amplifier (e.g., a low-noise amplifier (LNA)) configured to amplify the received signal. The receiver chain 910 may include at least one demodulator configured to demodulate the receive signal and obtain the transmitted data by reversing the modulation technique applied during transmission of the signal. The receiver chain 910 may include at least one decoder for decoding the processing the demodulated signal to receive the transmitted data.

A transmitter chain 912 may be configured to generate and transmit signals (e.g., control information, data, packets). The transmitter chain 912 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 912 may also include at least one power amplifier configured to amplify the modulated signal to an appropriate power level suitable for transmission over the wireless medium. The transmitter chain 912 may also include one or more antennas for transmitting the amplified signal into the air or wireless medium.

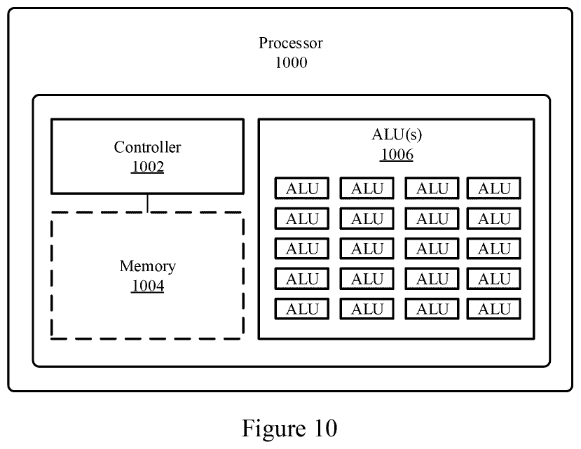

FIG. 10 illustrates an example of a processor 1000 in accordance with aspects of the present disclosure. The processor 1000 may be an example of a processor configured to perform various operations in accordance with examples as described herein. The processor 1000 may include a controller 1002 configured to perform various operations in accordance with examples as described herein. The processor 1000 may optionally include at least one memory 1004, which may be, for example, an L1/L2/L3 cache. Additionally, or alternatively, the processor 1000 may optionally include one or more arithmetic-logic units (ALUs) 1006. One or more of these components may be in electronic communication or otherwise coupled (e.g., operatively, communicatively, functionally, electronically, electrically) via one or more interfaces (e.g., buses).

The processor 1000 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1000) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1002 may be configured to manage and coordinate various operations (e.g., signaling, receiving, obtaining, retrieving, transmitting, outputting, forwarding, storing, determining, identifying, accessing, writing, reading) of the processor 1000 to cause the processor 1000 to support various operations in accordance with examples as described herein. For example, the controller 1002 may operate as a control unit of the processor 1000, generating control signals that manage the operation of various components of the processor 1000. These control signals include enabling or disabling functional units, selecting data paths, initiating memory access, and coordinating timing of operations.

The controller 1002 may be configured to fetch (e.g., obtain, retrieve, receive) instructions from the memory 1004 and determine subsequent instruction(s) to be executed to cause the processor 1000 to support various operations in accordance with examples as described herein. The controller 1002 may be configured to track memory address of instructions associated with the memory 1004. The controller 1002 may be configured to decode instructions to determine the operation to be performed and the operands involved. For example, the controller 1002 may be configured to interpret the instruction and determine control signals to be output to other components of the processor 1000 to cause the processor 1000 to support various operations in accordance with examples as described herein. Additionally, or alternatively, the controller 1002 may be configured to manage flow of data within the processor 1000. The controller 1002 may be configured to control transfer of data between registers, arithmetic logic units (ALUs), and other functional units of the processor 1000.

The memory 1004 may include one or more caches (e.g., memory local to or included in the processor 1000 or other memory, such RAM, ROM, DRAM, SDRAM, SRAM, MRAM, flash memory, etc. In some implementations, the memory 1004 may reside within or on a processor chipset (e.g., local to the processor 1000). In some other implementations, the memory 1004 may reside external to the processor chipset (e.g., remote to the processor 1000).

The memory 1004 may store computer-readable, computer-executable code including instructions that, when executed by the processor 1000, cause the processor 1000 to perform various functions described herein. The code may be stored in a non-transitory computer-readable medium such as system memory or another type of memory. The controller 1002 and/or the processor 1000 may be configured to execute computer-readable instructions stored in the memory 1004 to cause the processor 1000 to perform various functions. For example, the processor 1000 and/or the controller 1002 may be coupled with or to the memory 1004, the processor 1000, the controller 1002, and the memory 1004 may be configured to perform various functions described herein. In some examples, the processor 1000 may include multiple processors and the memory 1004 may include multiple memories. One or more of the multiple processors may be coupled with one or more of the multiple memories, which may, individually or collectively, be configured to perform various functions herein.

The one or more ALUs 1006 may be configured to support various operations in accordance with examples as described herein. In some implementations, the one or more ALUs 1006 may reside within or on a processor chipset (e.g., the processor 1000). In some other implementations, the one or more ALUs 1006 may reside external to the processor chipset (e.g., the processor 1000). One or more ALUs 1006 may perform one or more computations such as addition, subtraction, multiplication, and division on data. For example, one or more ALUs 1006 may receive input operands and an operation code, which determines an operation to be executed. One or more ALUs 1006 be configured with a variety of logical and arithmetic circuits, including adders, subtractors, shifters, and logic gates, to process and manipulate the data according to the operation. Additionally, or alternatively, the one or more ALUs 1006 may support logical operations such as AND, OR, exclusive-OR (XOR), not-OR (NOR), and not-AND (NAND), enabling the one or more ALUs 1006 to handle conditional operations, comparisons, and bitwise operations.

The processor 1000 may support wireless communication in accordance with examples as disclosed herein. The processor 1000 may be configured to support a means for receiving an overlaid SS block that includes an overlaid OFDM sequence within an OOK ON symbol, wherein the overlaid OFDM sequence comprises an SS having a PSS and an SSS overlaid within OOK ON symbols of a binary sequence of the OOK and detecting the SS within the overlaid SS block.

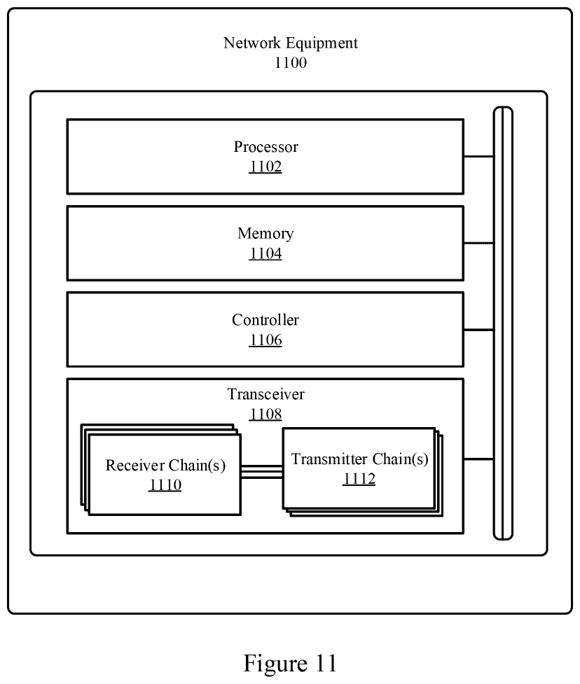

FIG. 11 illustrates an example of a NE 1100 in accordance with aspects of the present disclosure. The NE 1100 may include a processor 1102, a memory 1104, a controller 1106, and a transceiver 1108. The processor 1102, the memory 1104, the controller 1106, or the transceiver 1108, or various combinations thereof or various components thereof may be examples of means for performing various aspects of the present disclosure as described herein. These components may be coupled (e.g., operatively, communicatively, functionally, electronically, electrically) via one or more interfaces.

The processor 1102, the memory 1104, the controller 1106, or the transceiver 1108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1102 may include an intelligent hardware device (e.g., a general-purpose processor, a DSP, a CPU, an ASIC, an FPGA, or any combination thereof). In some implementations, the processor 1102 may be configured to operate the memory 1104. In some other implementations, the memory 1104 may be integrated into the processor 1102. The processor 1102 may be configured to execute computer-readable instructions stored in the memory 1104 to cause the NE 1100 to perform various functions of the present disclosure.

The memory 1104 may include volatile or non-volatile memory. The memory 1104 may store computer-readable, computer-executable code including instructions when executed by the processor 1102 cause the NE 1100 to perform various functions described herein. The code may be stored in a non-transitory computer-readable medium such the memory 1104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1102 and the memory 1104 coupled with the processor 1102 may be configured to cause the NE 1100 to perform one or more of the functions described herein (e.g., executing, by the processor 1102, instructions stored in the memory 1104).

For example, the processor 1102 may support wireless communication at the NE 1100 in accordance with examples as disclosed herein. The NE 1100 may be configured to support a means for configuring an overlaid SS block to include an overlaid orthogonal OFDM sequence within an OOK ON symbol, wherein the overlaid OFDM sequence comprises an SS having a PSS and an SSS overlaid within one or more OOK ON symbols included in a binary sequence of the OOK and transmitting the configured overlaid SS block in an OFDM symbol included in a slot.

The controller 1106 may manage input and output signals for the NE 1100. The controller 1106 may also manage peripherals not integrated into the NE 1100. In some implementations, the controller 1106 may utilize an operating system such as iOS®, ANDROID®, WINDOWS®, or other operating systems. In some implementations, the controller 1106 may be implemented as part of the processor 1102.

In some implementations, the NE 1100 may include at least one transceiver 1108. In some other implementations, the NE 1100 may have more than one transceiver 1108. The transceiver 1108 may represent a wireless transceiver. The transceiver 1108 may include one or more receiver chains 1110, one or more transmitter chains 1112, or a combination thereof.

A receiver chain 1110 may be configured to receive signals (e.g., control information, data, packets) over a wireless medium. For example, the receiver chain 1110 may include one or more antennas for receive the signal over the air or wireless medium. The receiver chain 1110 may include at least one amplifier (e.g., a low-noise amplifier (LNA)) configured to amplify the received signal. The receiver chain 1110 may include at least one demodulator configured to demodulate the receive signal and obtain the transmitted data by reversing the modulation technique applied during transmission of the signal. The receiver chain 1110 may include at least one decoder for decoding the processing the demodulated signal to receive the transmitted data.

A transmitter chain 1112 may be configured to generate and transmit signals (e.g., control information, data, packets). The transmitter chain 1112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1112 may also include at least one power amplifier configured to amplify the modulated signal to an appropriate power level suitable for transmission over the wireless medium. The transmitter chain 1112 may also include one or more antennas for transmitting the amplified signal into the air or wireless medium.

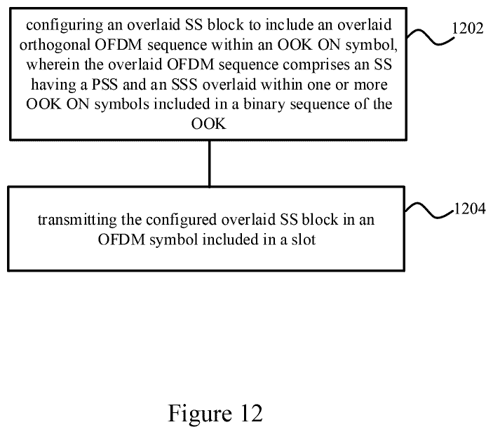

FIG. 12 illustrates a flowchart of a method in accordance with aspects of the present disclosure. The operations of the method may be implemented by an NE as described herein. In some implementations, the NE may execute a set of instructions to control the function elements of the NE to perform the described functions.

At 1202, the method may include configuring an overlaid SS block to include an overlaid orthogonal OFDM sequence within an OOK ON symbol, wherein the overlaid OFDM sequence comprises an SS having a PSS and an SSS overlaid within one or more OOK ON symbols included in a binary sequence of the OOK. The operations of 1202 may be performed in accordance with examples as described herein. In some implementations, aspects of the operations of 1202 may be performed by an NE as described with reference to FIG. 11.

At 1204, the method may include transmitting the configured overlaid SS block in an OFDM symbol included in a slot. The operations of 1204 may be performed in accordance with examples as described herein. In some implementations, aspects of the operations of 1204 may be performed by an NE as described with reference to FIG. 11.

It should be noted that the method described herein describes a possible implementation, and that the operations and the steps may be rearranged or otherwise modified and that other implementations are possible.

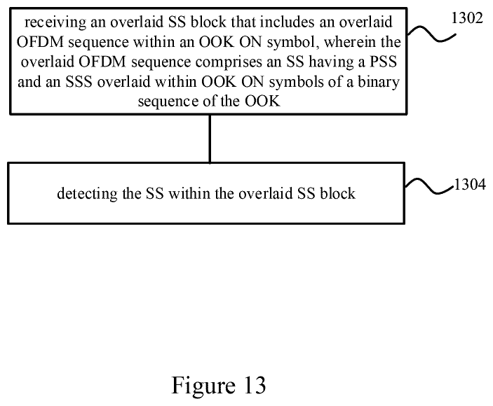

FIG. 13 illustrates a flowchart of a method in accordance with aspects of the present disclosure. The operations of the method may be implemented by a UE as described herein. In some implementations, the UE may execute a set of instructions to control the function elements of the UE to perform the described functions.

At 1302, the method may include receiving an overlaid SS block that includes an overlaid OFDM sequence within an OOK ON symbol, wherein the overlaid OFDM sequence comprises an SS having a PSS and an SSS overlaid within OOK ON symbols of a binary sequence of the OOK. The operations of 1302 may be performed in accordance with examples as described herein. In some implementations, aspects of the operations of 1302 may be performed by a UE as described with reference to FIG. 9.

At 1304, the method may include detecting the SS within the overlaid SS block. The operations of 1304 may be performed in accordance with examples as described herein. In some implementations, aspects of the operations of 1304 may be performed by a UE as described with reference to FIG. 9.

It should be noted that the method described herein describes a possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
at least one memory; and
at least one processor coupled with the at least one memory and configured to cause the network entity to:
configure an overlaid synchronization signal (SS) block (SS block) to include an overlaid orthogonal frequency division multiplexing (OFDM) sequence within an ON-OFF keying (OOK) ON symbol,
wherein the overlaid OFDM sequence comprises an SS having a primary synchronization signal (PSS) and a secondary synchronization signal (SSS) overlaid within one or more OOK ON symbols included in a binary sequence of the OOK; and
transmit the configured overlaid SS block in an OFDM symbol included in a slot.

2. The network entity of claim 1, wherein the at least one processor is configured to cause the network entity to generate the OOK symbol using one OFDM symbol, wherein the OOK symbol comprises an OOK chip.

3. The network entity of claim 1, wherein the at least one processor is configured to cause the network entity to generate multiple OOK symbols using one OFDM symbol, wherein each OOK symbol comprises an OOK chip.

4. The network entity of claim 3, wherein the at least one processor is configured to cause the network entity to generate the multiple OOK symbols using a discrete Fourier transform (DFT) or a least squares (LS) transform.

5. The network entity of claim 1, wherein an overlaid SS mapping within the binary sequence of the OOK comprises the PSS transmitted within a first occurrence of the OOK ON symbol in the OFDM symbol and the SSS transmitted within a second occurrence of the OOK ON symbol in the OFDM symbol, and wherein the PSS and SSS are mapped to adjacent chips of multiple chips associated with the one or more OOK ON symbols.

6. The network entity of claim 1, wherein an overlaid SS mapping within the binary sequence of the OOK comprises a first PSS adjacent to a second PSS, and wherein the first PSS and the second PSS are mapped to adjacent chips of multiple chips associated with the one or more OOK ON symbols.

7. The network entity of claim 1, wherein an overlaid SS mapping within the binary sequence of the OOK comprises a first SSS adjacent to a second SSS, and wherein the first SSS and the second SSS are mapped to adjacent chips of multiple chips associated with the one or more OOK ON symbols.

8. The network entity of claim 1, wherein the at least one processor is further configured to cause the network entity to:
transmit the overlaid SS block within the binary sequence of the OOK at a same default candidate location in the slot where the PSS and SSS are transmitted.

9. The network entity of claim 1, wherein the overlaid SS block comprises two repeated PSSs adjacent to two repeated SSSs.

10. The network entity of claim 1, wherein the at least one processor is further configured to cause the network entity to:
transmit, using multiple beams, an overlaid sequence burst containing multiple overlaid SS blocks.

11. The network entity of claim 1, wherein the at least one processor is further configured to cause the network entity to:
transmit a physical cell identifier for the network entity that comprises the PSS, the SSS, and the overlaid SS.

12. A method performed by a network entity, the method comprising:
configuring an overlaid synchronization signal (SS) block (SS block) to include an overlaid orthogonal frequency division multiplexing (OFDM) sequence within an ON-OFF keying (OOK) ON symbol,
wherein the overlaid OFDM sequence comprises an SS having a primary synchronization signal (PSS) and a secondary synchronization signal (SSS) overlaid within one or more OOK ON symbols included in a binary sequence of the OOK; and
transmitting the configured overlaid SS block in an OFDM symbol included in a slot.

13. The method of claim 12, further comprising:
generating the OOK symbol using one OFDM symbol, wherein the OOK symbol comprises an OOK chip.

14. The method of claim 12, further comprising:
generating multiple OOK symbols using one OFDM symbol, wherein each OOK symbol comprises an OOK chip.

15. The method of claim 12, further comprising
transmitting a physical cell identifier for the network entity that comprises the PSS, the SSS, and the overlaid SS.

16. A user equipment (UE) for wireless communication, comprising:
at least one memory; and
at least one processor coupled with the at least one memory and configured to cause the UE to:
receive an overlaid synchronization signal (SS) block (SS block) that includes an overlaid orthogonal frequency division multiplexing (OFDM) sequence within an ON-OFF keying (OOK) ON symbol,
wherein the overlaid OFDM sequence comprises an SS having a primary synchronization signal (PSS) and a secondary synchronization signal (SSS) overlaid within OOK ON symbols of a binary sequence of the OOK; and
detect the SS within the overlaid SS block.

17. The UE of claim 16, wherein the overlaid SS block comprises two repeated PSSs adjacent to two repeated SSSs.

18. The UE of claim 16, wherein the at least one processor is further configured to cause the UE to:
perform an initial synchronization with a network entity using the OFDM sequence; and
determine a cell identifier for the network entity using the PSS, the SSS and the overlaid SS.

19. A processor for wireless communication, the processor comprising:
at least one controller coupled with at least one memory and configured to cause the processor to:
receive an overlaid synchronization signal (SS) block (SS block) that includes an overlaid orthogonal frequency division multiplexing (OFDM) sequence within an ON-OFF keying (OOK) ON symbol,
wherein the overlaid OFDM sequence comprises an SS having a primary synchronization signal (PSS) and a secondary synchronization signal (SSS) overlaid within OOK ON symbols of a binary sequence of the OOK; and
detect the SS within the overlaid SS block.

20. The processor of claim 19, wherein the overlaid SS block comprises two repeated PSSs adjacent to two repeated SSSs.
